(19) United States
(12) Patent Application Publication
(10) Pub. No.: US 2008/0295383 A1
(43) Pub. Date: Dec. 4, 2008

(54) Fishing pole tender system

(75) Inventors: Stephen Wakefield, Hobe Sound, FL (US); Martin Schaus, Burmingham, MI (US)

Correspondence Address: AKERMAN SENTERFITT, P.O. BOX 3188, WEST PALM BEACH, FL, 33402-3188, US

(73) Assignee: Moto, LLC, Hobe Sound, FL (US)

(21) Appl. No.: 12/134,712

(22) Filed: Jun. 6, 2008

Related U.S. Application Data
(63) Continuation-in-part of application No. 11/769,526, filed on Jun. 27, 2007.
Application No. 11/769,526 is a continuation-in-part of application No. 11/670,299, filed on Feb. 1, 2007.

(51) Int. Cl. A01K 97/10

(52) U.S. Cl. 43/21.2; 248/534

(57) ABSTRACT

A fishing pole tender system for temporary attachment to a horizontal support structure, such as a bench seat provided on a boat. The tender system includes a generally rigid frame having a top sized to extend over the support structure, the top having a first end and a second end. A first side depends perpendicularly from the first end of the top. A second side depends perpendicularly from the second end of the top, and has a first section that is parallel with the first side, and a second section that is inclined inwardly towards the first side, with the first section sized to extend over a vertical depth of the support structure such that the second section extends at least partially underneath the support structure. A fishing pole holder is secured to the first side, formed of a hollow sleeve having a notch therein for receiving a fishing reel.

### CROSS REFERENCE TO RELATED APPLICATION

This application is a continuation-in-part claiming priority to currently pending U.S. patent application Ser. No. 11/769,526 filed on Jun. 27, 2007 entitled FISHING POLE TENDER SYSTEM, which in turn is a continuation-in-part application claiming priority to currently pending U.S. patent application Ser. No. 11/670,299 filed on Feb. 1, 2007, entitled FISHING POLE TENDER SYSTEM, the entirety of which are hereby incorporated by reference.

### STATEMENT REGARDING FEDERALLY SPONSORED RESEARCH OR DEVELOPMENT

Not applicable.

### FIELD OF INVENTION

This invention relates generally to a fishing pole tender system, which may include a fishing pole holder that can be temporarily attached to a horizontal support structure such as a bench seat on a boat.

### BACKGROUND

Fishing is a popular form of recreation and source of fresh seafood for individuals with access to lakes, rivers, oceans and other water bodies where fish can be found. The most common form of recreational fishing, angling, uses a pole, reel, line, hooks and any of a wide range of baits, both living and man-made. As is well known, it may take an extended period of fishing for the angler to catch a fish. While waiting for a fish to bite, the angler may need to put down his fishing pole to use his hands to attend to something else or otherwise leave the fishing pole unattended. If the pole is simply left on a surface unattended, the pole can be pulled into the water or along the surface and be lost or damaged when a fish takes the bait. In addition, if the angler cannot see whether the fishing line is pulled taught, he may not notice that a fish has taken the bait. This is critical since the chance that the fish will take the bait without being caught increases if an angler does not set the hook in the fish's mouth shortly after the fish takes the bait. Recognition of these deficiencies led to the development of devices for tending to a fishing pole while an angler uses his hands for something else.

Many anglers fish from a recreational boat, such as a rowing boat, but the boat may not have anywhere against which to conveniently prop the fishing pole. Due to the movement of the boat in the water, this can often make it impossible for the angler to let go of the fishing pole during the time that he is fishing. If the angler owns the boat, he may be able to affix a fishing pole holder to the side of the boat, but this is not possible if the angler is renting the boat, or does not want to damage the boat or otherwise permanently affix something to the boat. Larger boats may have fishing pole holders attached to the side railings, for example, at the stern of the boat. However, an angler may desire to use more fishing poles than are provided for, or may wish to fish from a different part of the boat. Additionally, an angler may fish from an inflatable dinghy or canoe, and in that instance it may not be possible to hook anything to the side of the boat or to permanently attach anything to the side of the boat.

Fishing pole holders are known in the art. U.S. Pat. No. 4,156,982 describes a unitary support for a fishing rod with spaced parallel plates that may straddle a bridge railing or the gunwale of a boat. The plates are rigidly connected by a trough, which can be used as a storage space. The unitary support is attached to a bridge railing or boat gunwale using an adjustable clamping screw. The fishing pole rests in a notch in one of the parallel plates and through a hole of the other parallel plate.

U.S. Pat. No. 5,054,738 describes a utility device designed to securely hold one or more fishing rods and a single beverage container. The utility device includes spaced parallel plates creating an inverted, U-shaped configuration for attachment to a dock rail or boat rail. The utility device is attached to a rail using a pin that passes through a hole in each leg of the U-shaped portion before a cotter pin is inserted in a hole in the tip of the pin.

U.S. Pat. No. 5,561,937 describes a fishing rod holder with a triangular support brace having a recess dimensioned to receive an elongated hollow tube for holding a fishing pole. The triangular support brace can be positioned atop a bridge rail and can be secured using a strap that wraps around both the triangular support brace and the rail. A dangling pouch can be temporarily attached to the strap using a button snap.

U.S. Patent Application Publication 2005/0039377 describes a fishing post cap with a square shaped recess formed from two sets of opposing sides that are parallel to one another. The fishing post cap is a unitary device that permanently includes accessories such as cup holders, mini-tackle boxes, a fishing pole holder and gear hooks. The gear hooks can be used to hang items such as towels, a live well, a fish basket, and a fish stringer.

Thus, there is a need for improved fishing rod holders that can be easily used on board boats.

### SUMMARY OF THE INVENTION

The present disclosure is directed to a fishing pole tender system for temporary attachment to a horizontal support structure, such as a bench seat provided on a boat.

The fishing pole tender system can include a generally rigid frame having a top sized to extend over the horizontal support structure, the top having a first end and a second end. A first side can depend perpendicularly from the first end of the top. A second side can depend perpendicularly from the second end of the top, the second side having a first section that is parallel with the first side, and a second section that is inclined inwardly towards the first side, the first section sized to extend over a vertical depth of the horizontal support structure such that the second section extends at least partially underneath the horizontal support structure. A Fishing pole holder can be secured to the first side, the fishing pole holder comprising a hollow sleeve having a notch therein for receiving a fishing pole reel.

A securing means can attached to the second side, for securing the fishing pole tender system to the horizontal support structure.

The hollow sleeve can be open at both ends thereof, so that the rod handle can extend below the bottom of the sleeve.

The notch in the hollow sleeve can be provided at a top end of the hollow sleeve, and the hollow sleeve can have a lip extending around the top end and the notch.

The generally rigid frame can be formed of metal, and the hollow sleeve can be formed of plastic.

An accessory holder may be mounted to the second side of the rigid frame. The accessory holder can be a cup sized to receive a drinks can, which can also be used to receive other items such as bottles, sun block or any fishing tackle, tools, or other accessories. The cup can be formed of perforated material. The accessory holder can be removably mounted to the second side of the rigid frame.

These and other arrangements are described in more detail below.

### BRIEF DESCRIPTION OF THE DRAWINGS

The accompanying drawings, which are incorporated in and form a part of the specification, illustrate arrangements of the presently disclosed invention and, together with the description, disclose the principles of the invention.

FIG. 1 is a side view of a fishing pole tender system, including a rigid frame and a fishing pole holder.

FIG. 2 is a perspective view of the fishing pole tender system of FIG. 1 mounted on a horizontal support structure, with an attached accessory portion.

### DETAILED DESCRIPTION OF THE INVENTION

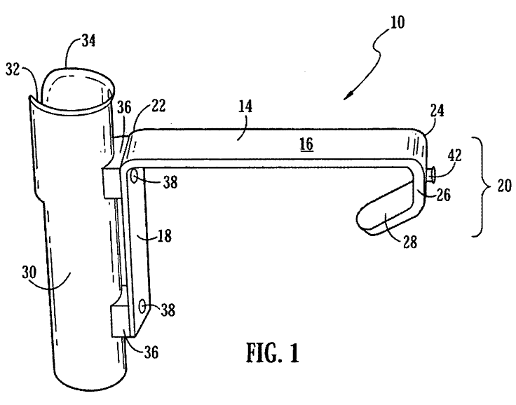

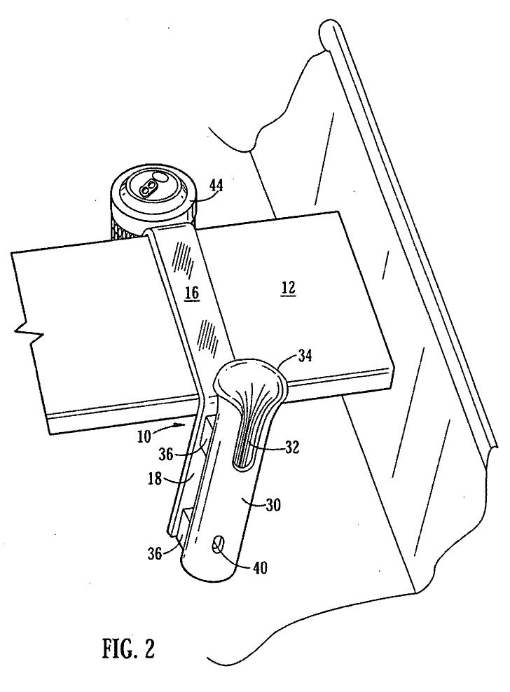

As shown in FIGS. 1 and 2, this invention is directed to a fishing pole tender system 10 for temporary and removable attachment to a horizontal support structure 12, which may be a bench seat provided on a boat. The fishing pole tender system 10 can include a rigid frame 14 which can have a top 16, a first side 18 and a second side 20 opposite the first side 18. It will be appreciated that although the horizontal support structure 12 is generally referred to as a bench seat herein, the fishing pole tender system 10 may be used with any suitable horizontal support structure such as a beam, strut, brace or any other similar structure.

The top 16 has first and second ends 22, 24 and can be sized such that it is slightly longer than the width of a horizontal support structure 12. The first side 18 extends perpendicularly from the first end 22, and the second side 20 extends perpendicularly from the second end 24. The sides thus fit relatively snugly over the horizontal support structure 12.

In the illustrated arrangement, the frame 14 is formed of one strip of metal, such as steel. Thus, the join between the first and second sides 18, 20 and the top 16 may be formed by bends in the metal strip. It will be appreciated that the frame can be formed of separate pieces that are joined together. It will also be appreciated that the frame can be formed of any suitable material, including metals, alloys, thermoplastics, thermoset plastics, fibers, and any combinations thereof. If the frame is formed of metal, it is preferably painted or coated to protect the metal from rusting or other degradation due to water damage.

The second side 20 may include two portions 26, 28. The first portion 26 can extend generally parallel to the first side 18, from the second end of the top 16. The first portion 26 can be slightly longer than the depth of the horizontal support structure 12. The second portion 28 can extend at an inclined angle towards the first side 18, such that it extends at least partially underneath the horizontal support structure 12 when in use. A suitable angle of incline may be approximately 30-60° and preferably 45° to the plane of the first portion 26, but any suitable angle may be used.

The dimensions of the frame 14 can be varied, such that a variety of sizes may be supplied so a user can select the size of frame that best matches the size of the horizontal support structure 12 on which they wish to use the fishing pole tender system. Alternatively, the frame 14 can be made to fit a particular size of support structure 12.

The frame 14 can be resiliently deformable. In order to place the frame 14 on a horizontal support structure 12 such as a bench seat, the second portion 28 of the second side 20 may be hooked under the structure 12, and the frame 14 can be snapped into place by bringing the first side 18 downwardly until it rests against a side of the horizontal support structure 12.

A fishing pole holder 30 can be attached to the first side 18 of the frame 14. The fishing pole holder 30 can be formed of a hollow lightweight plastic or PVC sleeve, but can be formed of any suitable material. The fishing pole holder 30 may be open at both ends thereof. A notch 32 can be included in a top end of the fishing pole holder 30. The notch is preferably deep and wide enough to accommodate a fixing bracket for a fishing reel attached to a fishing rod placed in the holder 30, with the reel resting on the outside of the holder 30. A lip 34 is preferably formed around the top end of the holder 30 and the notch 32. The notch 32 can be designed to prevent rotation of the pole within the fishing pole holder 30.

Two mounting blocks 36 may be provided to mount the fishing pole holder 30 to the first side 18 of the frame 14. The holder 30 may be attached to the frame 14 by means of screws 38 passing through the mounting blocks 36. A screw access hole 40 may be provided in the front of the holder 30, opposite one of the blocks 36, to allow a screwdriver to be used to affix the screw 38 in place. The other screw 38 may be accessed by passing a screwdriver into the notch 32.

The fishing pole holder 30 can be designed to allow force transfer from a fishing pole (not shown) placed in the fishing pole holder 30 to the frame 14, which transfers the force to the support structure 12 and prevents the fishing pole from pivoting out of the fishing pole holder 30 and into the water when the fish takes the bait.

A securing screw 42 may be included in the second side 20 for improving attachment of the frame to the support structure 12.

The securing screw 42 can be used to impart additional compressive force onto the support structure 12. In addition, a sharp point of the securing screw 42 can serve to anchor the frame 14 to the support structure 12. This is especially true for support structures 12, such as wood, that can be compacted when a concentrated force, such as the force exerted by the tip of the securing screw 42, are applied. Although the securing screw 42 can be driven into a support structure 12, a securing screw 42 need not be driven into the support structure 12 to achieve secure temporary attachment to a support structure 12, and the screw 42 may have a rounded end to achieve such attachment by compressive force alone.

An accessory holder 44 can be optionally included, and may be releasably secured to the screw 42, for example using a keyhole shaped hanging aperture (not shown). The accessory holder 44 can be a cup sized to receive a standard drinks can or bottle. In a preferred arrangement, a body of the cup can be formed of a perforated material, such as a mesh or a plastic material having a plurality of holes. This allows for drainage of any liquid that may enter into the holder 44. Other sizes and shapes of accessory holders 44 can be used, and the invention is not limited in this regard.

The foregoing is provided for purposes of illustrating, explaining, and describing embodiments of this invention. Modifications and adaptations to these embodiments will be apparent to those skilled in the art and can be made without departing from the scope or spirit of this invention.

I claim:

1. A fishing pole tender system for temporary attachment to a horizontal support structure, comprising:
a generally rigid frame having:
a top sized to extend over the horizontal support structure, the top having a first end and a second end;
a first side depending perpendicularly from the first end of the top; and
a second side depending perpendicularly from the second end of the top, the second side having a first section that is parallel with the first side, and a second section that is inclined inwardly towards the first side, the first section sized to extend over a vertical depth of the horizontal support structure such that the second section extends at least partially underneath the horizontal support structure; and
a fishing pole holder secured to the first side, the fishing pole holder comprising a hollow sleeve sized to receive a fishing pole and having a notch therein for receiving a fishing pole reel.

2. The fishing pole tender system according to claim 1, wherein a securing means is attached to the second side, for securing the fishing pole tender system to the horizontal support structure.

3. The fishing pole tender system according to claim 1, wherein the hollow sleeve is open at both ends thereof.

4. The fishing pole tender system according to claim 1, wherein the notch in the hollow sleeve is provided at a top end of the hollow sleeve, and wherein the hollow sleeve has a lip extending around the top end and the notch.

5. The fishing pole tender system according to claim 1, wherein the generally rigid frame is formed of metal.

6. The fishing pole tender system according to claim 1, wherein the hollow sleeve is formed of plastic.

7. The fishing pole tender system according to claim 1, wherein an accessory holder is mounted to the second side of the rigid frame.

8. The fishing pole tender system according to claim 7, wherein the accessory holder is a cup sized to receive a drinks can.

9. The fishing pole tender system according to claim 8, wherein the cup is formed of perforated material.

10. The fishing pole tender system according to claim 7, wherein the accessory holder is removably mounted to the second side of the rigid frame.
